(19) United States
(12) Patent Application Publication
(10) Pub. No.: US 2016/0125692 A1
(43) Pub. Date: May 5, 2016

(54) WAGERING SYSTEM WITH HAND SPLITTING

(71) Applicants: Hwei-Wen Wayne Hong, Alameda, CA (US); Ivan E Hong, Alameda, CA (US)

(72) Inventors: Hwei-Wen Wayne Hong, Alameda, CA (US); Ivan E Hong, Alameda, CA (US)

(21) Appl. No.: 14/679,031

(22) Filed: Apr. 6, 2015

Related U.S. Application Data
(60) Provisional application No. 62/074,226, filed on Nov. 3, 2014.
(60) Provisional application No. 62/077,832, filed on Nov. 10, 2014.

(51) Int. Cl. G07F 17/32

(52) U.S. Cl. CPC G07F 17/3244

(57) ABSTRACT

A casino wagering game which enables the player to make two ante wagers and one blind bet, and then split a four card dealt hand into two separate hands. The player can raise or fold on each of the two player hands. The split hands do not need to be of equal size, and the dealer will supplement each hand so that player's each separate hand has a predetermined number of cards (e.g., three). The dealer's hand has four cards with only one revealed to the players. The dealer (after the players have acted) will reveal all three remaining cards and discard the card which makes the best possible three card hand with the remaining dealer's cards. Then each of the two player's hands is compared to the dealer's hand and the wagers are resolved accordingly.

### CROSS REFERENCE TO RELATED APPLICATIONS

This application claims benefit to U.S. provisional application 62/074,226, which is incorporated by reference herein in its entirety. This application also claims benefit to U.S. provisional application 62/077,832 which is incorporated by reference herein in its entirety.

### BACKGROUND OF THE INVENTION

1. Field of the Invention

The present general inventive concept is directed to a method, apparatus, and computer readable storage medium directed to a modified casino card game.

2. Description of the Related Art:

Casino games are well known. Casino operators are always looking for improved games in which players will find exciting and casinos will find profitable.

### SUMMARY OF THE INVENTION

It is an aspect of the present invention to provide an exciting casino game.

This together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method of implementing a casino wagering game using two ante wagers, according to an embodiment;

FIG. 2 is a flowchart illustrating exemplary methods of resolving individual player hands, according to an embodiment;

FIG. 3 is a flowchart illustrating an exemplary method of implementing a casino wagering game using one ante wager, according to an embodiment;

FIG. 4 is a drawing illustrated exemplary betting areas, according to an embodiment;

FIG. 5A is a drawing illustrating a gaming table, according to an embodiment;

FIG. 5B is a block diagram illustrating an electronic player tracking system associated with each gaming table, according to an embodiment;

FIG. 6A is a block diagram illustrating exemplary hardware that can be used to implement an electronic version of the methods described herein; and

FIG. 6B is a block diagram illustrating an exemplary network configuration to implement a player playing an online version of the methods described herein.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to implement a casino wagering game.

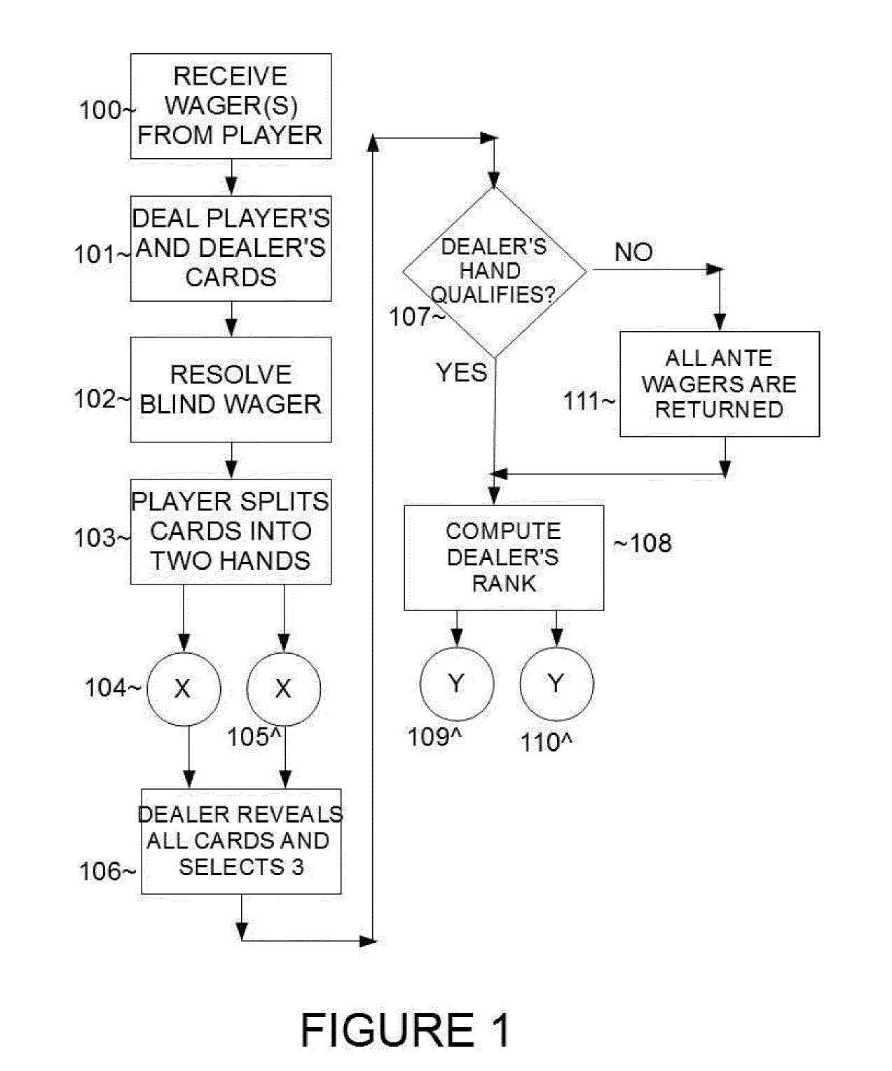

FIG. 1 is a flowchart illustrating an exemplary method of implementing a casino wagering game using two ante wagers, according to an embodiment.

In operation 100 the player places his/her wagers. The wagers are two ante wagers (required to play) and an optional blind (bonus) wager. The blind wager can be any amount (but must be at least the ante wager) but the two ante wagers have to be of equal amounts.

In an alternative embodiment, placing the blind wager is mandatory instead of being optional by the player.

From operation 100, the method proceeds to operation 101, which deals the player four cards and the dealer four cards. The player's four cards are dealt face up (or face down initially with the ability of the player to inspect the cards). The dealer's cards are dealt three cards face down with one card face up (the cards are not inspected by the dealer to choose which card to deal face up—there is no discretion as to which card to deal face up).

From operation 101, the method proceeds to operation 102 which resolves the blind wager based on a paytable. Table I below illustrates sample paytables for the blind wager. Of course other paytables can be used as well. If the player's hand comprises one of the winning hands in Table I then the player wins the payout applied to the blind wager and if the player does not have such a winning hand then the player loses the blind wager. For example if the player has four of a kind and the blind wager is $5 then the payout would be $1,000. In an alternative embodiment, the blind wager can also be resolved at the end of the game as well. The resolution of the blind bet has no bearing on the subsequent actions.

TABLE I

| | PAYOUT | PAYOUT | PAYOUT | |
|---|---|---|---|---|
| HAND | 1A | 1B | 1C | PAYOUT1D |
| Royal Flush | 500-to-1 | 500-to-1 | 500-to-1 | 600-to-1 |
| 4-of-a-Kind | 200-to-1 | 200-to-1 | 200-to-1 | 200-to-1 |
| Straight Flush | 60-to-1 | 80-to-1 | 100-to-1 | 100-to-1 |
| 3-of-a-Kind | 10-to-1 | 10-to-1 | 10-to-1 | 10-to-1 |
| Flush | 9-to-1 | 9-to-1 | 9-to-1 | 9-to-1 |
| Straight | 7-to-1 | 7-to-1 | 7-to-1 | 7-to-1 |
| Two Pairs | 5-to-1 | 5-to-1 | 5-to-1 | 5-to-1 |
| Ten's or Better | 2-to-1 | 2-to-1 | 2-to-1 | 2-to-1 |
| All Others | lose | lose | lose | lose |

From operation 102, the method proceeds to operation 103, wherein the player splits the player's initial four cards (dealt in operation 101) into two player hands. The hands do not need to be of equal size and can be one card/three cards or two cards/two cards or three cards/one cards. The player is not allowed to split cards into two hands and then discard any cards from any individual hand. The player can place down the two split hands on the table in any sequence. Of course, the player would typically want to split the hands in order to maximize the player's expected value of the game.

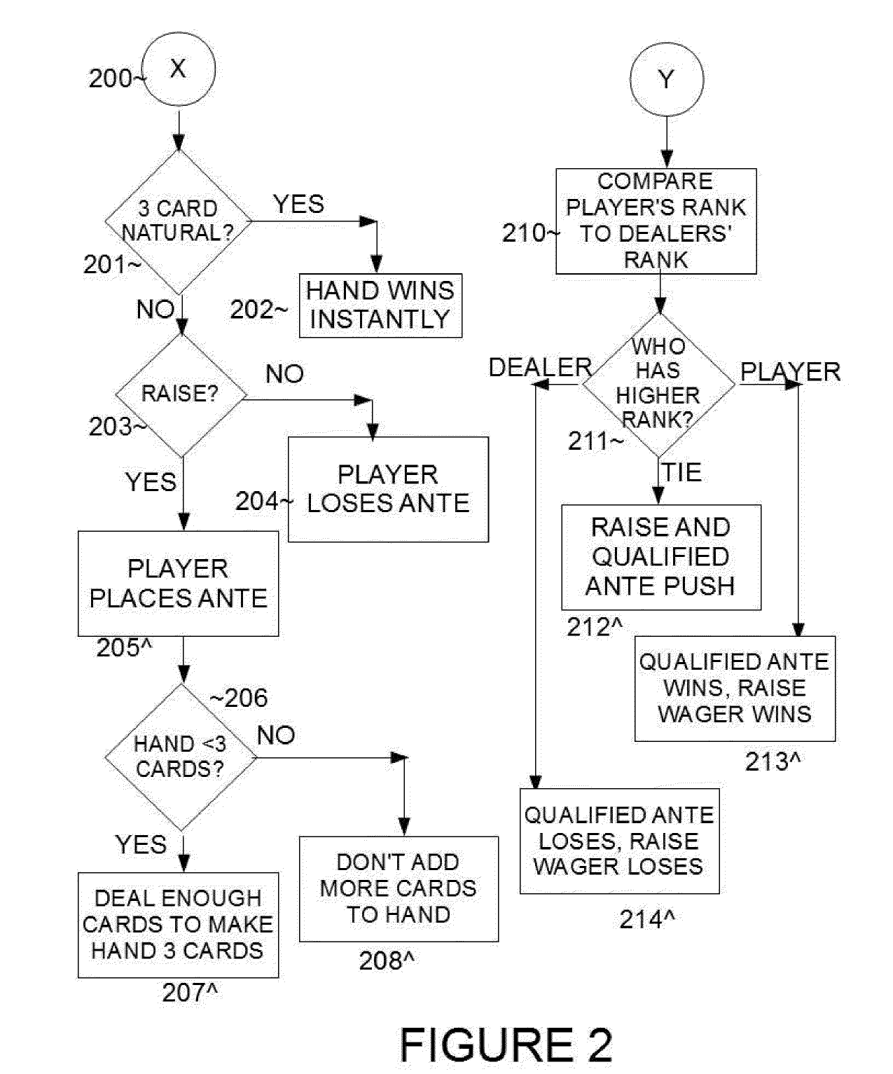

From operation 103, the player plays out each of the two hands (e.g., raises/folds and possibly draws new cards). The method proceeds to connector X 104 for the first player hand and again to connector X 105 for the second player hand. In other words, connector X 200 in FIG. 2 is implemented two separate and independent times for the first player's hand (after the player splits the initial cards) 104 and the second player's hand (after the player splits the initial cards) 105. Connector X 200 on FIG. 2 begins the method to play out each individual hand.

From connectors 104 and 105 (after the method starting with connector 200 from FIG. 2 has been completed), then the method proceeds to operation 106 in which the dealer reveals all of the dealer's cards and selects three out of the four cards as the dealer's three card hand, the selection being made using house rules with no discretion by a human dealer. The dealer would select the three cards to use (equivalent of selecting the one card to discard) optimally, that is so that the dealer has the highest ranking three card hand possible. Table II illustrates a set of three card poker ranks (from best/highest hand on top to worst/lowest on bottom). The same ranking applies to both the player's hand and the dealer's hand. In other words, the dealer would select the three dealer's cards which result in the dealer having the highest ranking hand. If it is possible to make two different hands of the same rank, then the dealer would select the higher hand (since higher hands beat lower hands). For example, if the dealer's four cards are 2-spades/4-spades/5-spades/3-spades, the dealer would choose 3-spades/4-spades/5-spades as the dealer's hand since this is the highest ranking straight flush (as opposed to choosing 2-spades/3-spades/4-spades which is also a straight flush but lower). The card the dealer discards is put aside so it is clear what the values of the dealer's three cards are (and should be clearly visible to all players).

TABLE II

Royal Flush (suited ace, king queen)
Straight Flush (suited consecutive cards)
Three of a kind
Straight
Flush
Pair
High card

Note that in one embodiment, the dealer's card that was dealt face up in operation 101 must be used in the dealer's hand (that is, the dealer cannot discard the revealed card). In another embodiment, the dealer is allowed to discard the dealer's revealed card when the dealer selects which card to discard.

From operation 106, the method proceeds to operation 107, which determines whether the dealer's hand qualifies. If the dealer's hand qualifies (is at least a predetermined rank) then the method proceeds to operation 108. If the dealer does not qualify then the method proceeds to operation 111. One qualifying hand/rank that can be used is queen-high (in other words, the dealer qualifies if the dealer's three card hand is at least queen-high), although other qualifying hands can be used (e g , king high, ace high, any pair, etc.)

If in operation 107, the dealer does not qualify then the method proceeds to operation 111 in which all of the player's ante wagers are returned to the player (e.g., they push). The game still continues and the method proceeds to operation 108.

In operation 107 if the dealer does qualify then the player's ante wagers are considered “qualified ante wagers” and the method proceeds to operation 108.

In operation 108, the dealer's rank is computed of the dealer's three card hand (formed in operation 106). A hierarchy (such as that in Table II) is used to determine the dealer's rank.

From operation 108, the method proceeds to resolve (determine whether it wins or loses and pay accordingly) each of the player's two hands. Thus, from operation 108, the method proceeds to connector Y twice (one for each of the player's two hands). In other words, the connector Y begins for the first player's hand and separately and independently connector Y begins for second player's hand.

FIG. 2 is a flowchart illustrating exemplary methods of resolving individual player hands, according to an embodiment. Connector X starts the method to enable the player to play out each of the player's two hands. Connector Y starts the method to enable resolution of each of the player's two hands.

The method to play out each of the player's hands begins with connector X 200.

In operation 201, it is determined whether the player's hand is a three-card natural. A three card natural hand is a three card flush hand or hands with higher ranking (e.g., 3-card flush, 3 card royal flush, 3-card straight, 3 of a kind, 3 card straight flush). If the player's hand is a three card natural, then the method proceeds to operation 202 in which this player's hand wins instantly without placing the raise bet. Then the resolution of this hand is over. For example, a paytable such as that illustrated in Table III can be used to pay the ante wager for this particular hand (paytable A and paytable B are just two different paytables that can be used). This particular hand has won and there is no further activity that would take place on this particular hand.

TABLE III

| Natural Hand | Paytable A | Paytable B |
|---|---|---|
| 3 card Royal Flush | 30 to 1 | 40 to 1 |
| 3 card Straight Flush | 15 to 1 | 15 to 1 |
| Three of a Kind | 8 to 1 | 8 to 1 |
| 3 card Straight | 3 to 1 | 2.5 to 1 |
| 3 card Flush | 2 to 1 | 2 to 1 |

If in operation 201, the hand is not a 3-card natural, then play continues to operation 203, which determines whether the player raises or not. If the player chooses not to raise, then the method proceeds to operation 204, wherein the player loses the ante for this particular hand and the resolution of this hand is over.

If the player raises, then the method proceeds to operation 205 in which the player places a raise wager equal in amount to the ante wager placed in operation 100.

From operation 205, the method proceeds to operation 206, which determines whether this particular hand has less than three cards. Each individual hand needs to have three cards. If the current hand has exactly three cards, then the method proceeds to operation 208 which ends the resolution (no additional cards are added to this hand). The method would then proceed from connector X in FIG. 1 to operation 106.

If in operation 206, the current hand has less than three cards (e.g., the player split the initial four cards so that this hand has one card and the other hand has three cards or split the initial four cards so that both hands have two cards) then the method proceeds to operation 207. In operation 207, the dealer deals additional supplementary cards to this particular player's hand so that the hand has exactly three cards (e.g., if the hand had one card then the dealer deals two cards, and if the hand had two cards then the dealer deals one card). This ends the resolution of this particular hand and the method would proceed from connector X in FIG. 1 to operation 106.

Note that in an alternative embodiment, operations 201 to 202 would be removed. In other words, three card naturals would not be automatically paid and would be treated like any other hand where the player can raise or fold.

Connector Y in FIG. 2 starts the method of resolving each individual hand.

In operation 210, the rank of the dealer's three card hand is compared to the rank of the current three card player's hand.

From operation 210, the method proceeds to operation 211, which determines who has the higher rank (dealer or player).

If in operation 211, it is determined that the dealer has the higher rank, then the method proceeds to operation 214, in which the qualified ante loses and the raise wager also loses. Note that if the dealer did not qualify then the ante wager for this player's hand would have pushed (returned) and is not taken by the dealer.

If in operation 211, it is determined that the player has the higher rank, then the method proceeds to operation 213 in which the qualified ante wins and the raise wager wins. Note that if the dealer did not qualify then the ante wager is not a qualified ante and this ante would push (be returned to the player). Note that the ante wager is paid even money and the raise wager is paid according to a paytable applied to this player's three card hand. For example, the paytables in Table III can be used or any other such paytable.

If in operation 211, it is determined that the player and dealer have equal ranks, then the method proceeds to operation 212 in which the ante wager (whether qualified or not) and raise wager pushes. Note that even if the player's hand and the dealer's hand have the same general rank, it is not necessarily a tie. For example, if the player's hand is three of a kind (three 5's) and the dealer's hand is three of a kind (three ace's), then because aces rank higher than 5's the dealer is considered to have the higher ranking hand. As another example, if the dealer hand is 2-spades/2-hearts/3-clubs and the player's hand is 2-clubs/2-clubs/3-hearts this would be a tie because both hands are a pair of 2's and one hand is not higher than the other. Note that 2-diamonds/2-diamonds/4-spades would beat the other hands because the lone card is higher (4 is higher than 3).

In operations 212, 213, 214, the resolution of this hand is complete.

Connector X 200 would be initiated for each of the two player hands. Connector Y 209 would be initiated for each of the two player hands.

If the bet amounts for ante and raise are the same, it is apparent that in the preceding descriptions of game procedures, the roles for ante and raise could be reversed.

Further embodiments can be implemented which vary the number of cards initially dealt to both the player and the dealer. Table IV below lists alternative embodiments.

TABLE IV

| Embodiment # | cards to player | cards to dealer | natural instant win? |
|---|---|---|---|
| BJ | 4 | 2 | yes for Blackjack |
| 1 | 4 | 4 | no |
| 2 | 4 | 4 | yes |
| 3 | 5 | 4 | no |
| 4 | 5 | 4 | yes |
| 5 | 6 | 4 | no |
| 6 | 6 | 4 | yes |
| 7 | 4 | 5 | no |
| 8 | 4 | 5 | yes |
| 9 | 5 | 5 | no |
| 10 | 5 | 5 | yes |
| 11 | 6 | 5 | no |
| 12 | 6 | 5 | yes |
| 13 | 4 | 6 | no |
| 14 | 4 | 6 | yes |
| 15 | 5 | 6 | no |
| 16 | 5 | 6 | yes |
| 17 | 6 | 6 | no |
| 18 | 6 | 6 | yes |

For each of the listed Embodiments, the competing game of choice could either be poker or blackjack variations. For example, when the dealer gets five initial cards, the dealer will still reveal one card but will then discard two cards when it is time for the dealer to reveal his/her hand. The competing game could be three-card poker. When the dealer gets six initial cards, the dealer will still reveal one card but will then discard two cards when it is time for the dealer to reveal his/her hand. The competing game could be four-card poker. In other embodiments, the dealer can reveal more than one card (e.g., two, three, etc.) In a further embodiment, instead of three card hands being formed and played against each other, other numbers of cards can be used as well, such as four card hands and five card hands. For example, in variations 17-18, the dealer would discard one card to form a five card dealer's hand, and the player would split their six card hand into two separate hands (with 1 to 5 cards) and the dealer would add as many cards onto each of the player's hands so that each player's hand has exactly five cards (instead of three cards as described above).

Blackjack variations can also be implemented (see “BJ” in Table IV). The player places 2 main bets and one Blind bet. The dealer is dealt two cards, the player is dealt four cards. The dealer then resolves the 4 Card Blind bet first. The Blind bet is the house bet (i.e. high house favor.) The player can split 4 cards into 3-1 or 2-2. If player has a blackjack (Ace and a 10, jack, queen, or king) he must put the blackjack in one hand and claim the winning at even money. After he splits into 2 cards, the player would hit like in regular blackjack. The two split blackjack hands are player's bets while the blind bet is the house bet.

When the player is dealt five initial cards, the hands can be resolved in the same way as with four initial cards. The player would split the initial five cards into two separate hands (but no hand can have more than three cards, so one hand would have three cards and one hand would have two cards which would then draw a card to make three cards). When the player is dealt six initial cards, the player would split the cards into two hands of three cards each with no drawing of cards necessary (since each hand already has three cards).

In a further embodiment, instead of requiring two ante wagers at the beginning of the game (as illustrated in FIG. 1), only one ante wager can be required.

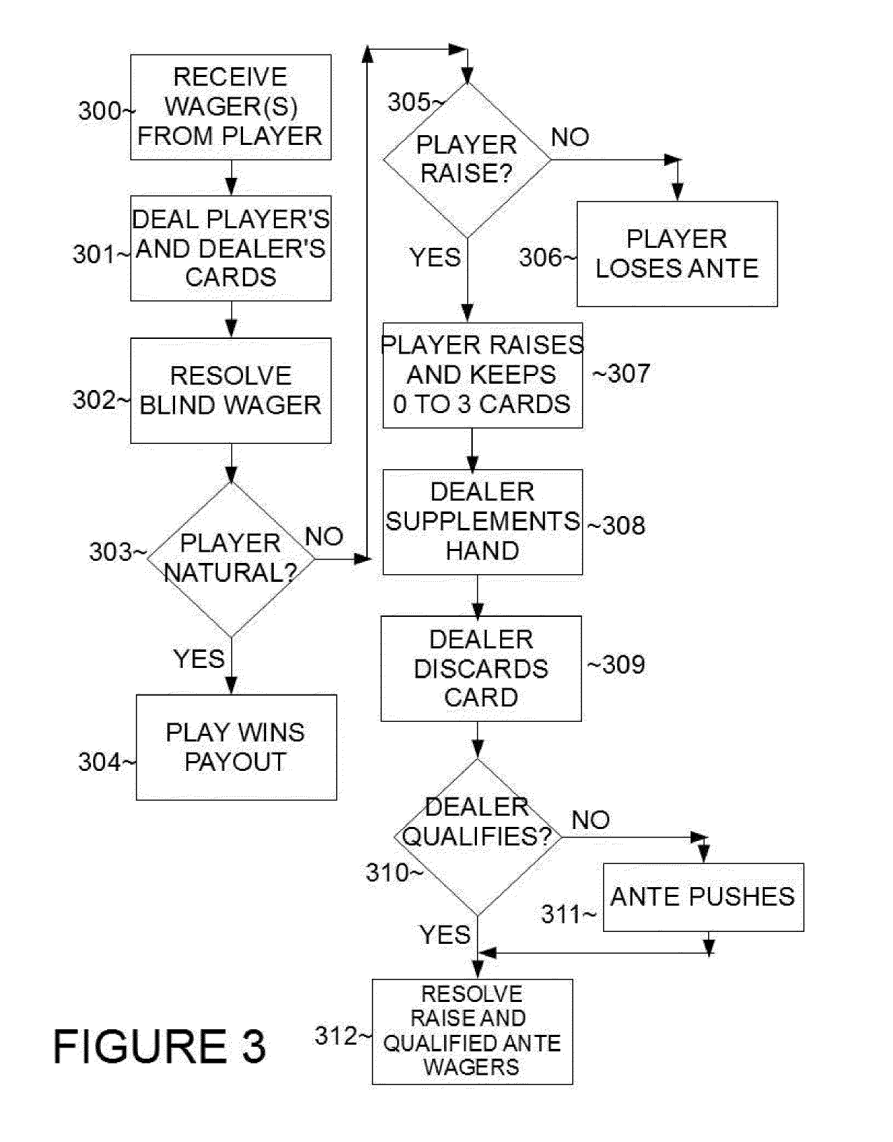

FIG. 3 is a flowchart illustrating an exemplary method of implementing a casino wagering game using one ante wager, according to an embodiment. Absent contrary statements, the same features described herein with regard to the two ante embodiment would also be applied to the one ante embodiment.

The method can begin with operation 300, which receives an ante wager from a player and a mandatory blind wager.

From operation 300, the method proceeds to operation 301 which deals the player's cards and the dealer's cards. Four cards are dealt to the player face up and four cards are dealt to the dealer with one face up and three face down.

From operation 301, the method proceeds to operation 302 which resolves the blind wager.

From operation 302 the method proceeds to operation 303 which determines whether the player's four cards include a three card natural. If so, then the method proceeds to operation 304, which pays a payout to the player on the ante wager using a paytable. The game ends here.

If in operation 303 the player does not have a natural, then the method proceeds to operation 305 which determines whether the player raises or folds. If the player does not raise (folds), then the method proceeds to operation 306 wherein the player loses his/her ante wager and the game ends.

If in operation 305 the player raises, then the method proceeds to operation 307. The player places a raise wager equal in value to the ante wager. The player also chooses how many cards and which cards to keep out of the original four cards dealt to the player. The player can choose from 0 to 3 cards to keep.

From operation 307, the method proceeds to operation 308 in which the dealer supplements the hand by dealing additional cards to the player's hand to ensure that the player has three cards. If the player kept three cards in operation 307 then the dealer would deal no cards in operation 308. If the player kept one card in operation 307, then the dealer would deal two cards. If the player kept two cards in operation 307, then the dealer would deal one card. If the player kept zero card in operation 307, then the dealer would deal three cards.

From operation 308, the method proceeds to operation 309 wherein the dealer discards a card from the dealer's initial four card hand resulting in a three card dealer's hand. The card the dealer would select to discard would be the card which would give the dealer the best hand (thus the decision is purely mechanical with no dealer discretion). All four dealer's cards are revealed.

From operation 309, the method proceeds to operation 310 which determines whether the dealer qualifies or not. If the dealer has at least a predetermined rank (e.g., queen high) then the dealer qualifies otherwise the dealer does not qualify.

If the dealer does not qualify then the method proceeds to operation 311 wherein the ante wager pushes (this remains true regardless of what happens in operation 312). The method then proceeds to operation 312.

If the dealer qualifies then the ante wager is considered a “qualified ante” (which can still win or lose) and the method proceeds to operation 312.

In operation 312, the dealer's hand is compared to the player's hand and the raise wager and any qualified ante and is resolved in the same manner is operations 210 to 214 from FIG. 2.

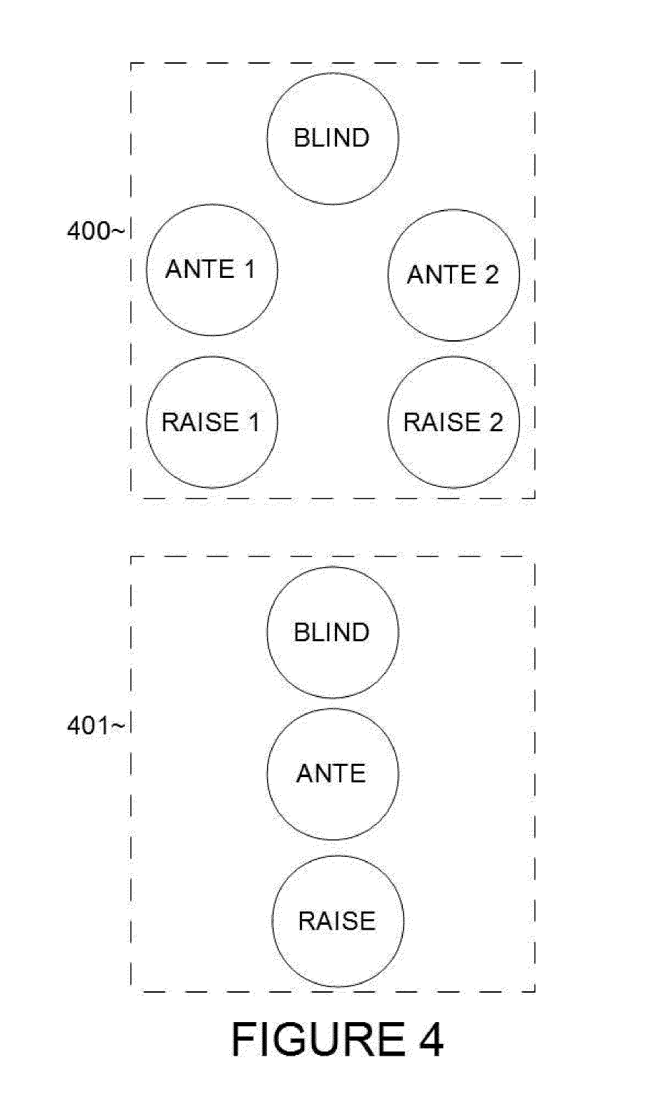

FIG. 4 is a drawing illustrated exemplary betting layouts/areas, according to an embodiment.

A casino gaming table would have a number of betting layouts/areas, one such betting area for each player so that the table can accommodate multiple simultaneous players. Each betting circle (they can be other shapes besides circles) is where the player places their respective wagers.

Two ante betting layout 400 is an exemplary betting layout used for the two ante embodiments described herein which has betting circles for each of the wagers in the game.

One hand betting layout 401 is an exemplary layout for use in the one ante embodiments described herein.

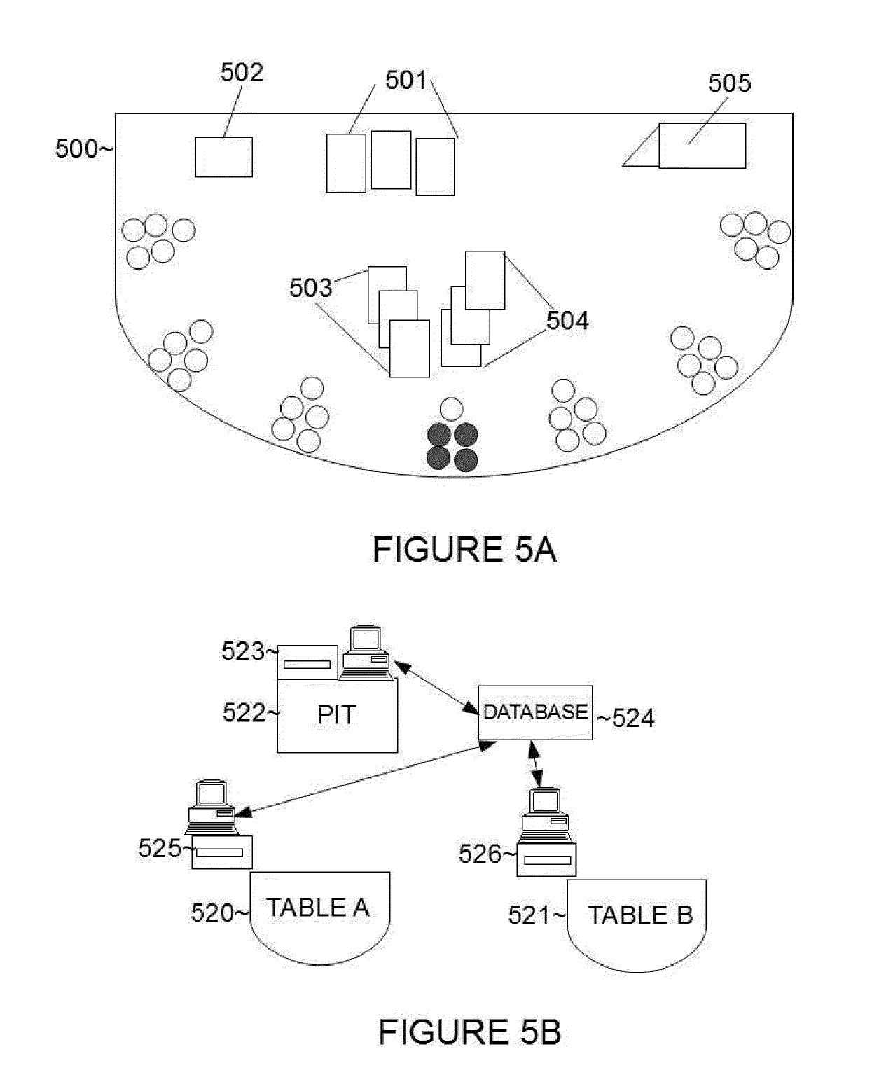

FIG. 5A is a drawing illustrating a gaming table, according to an embodiment.

A physical gaming table 500 (typically made of wood with felt on top with the layout imprinted on it) is used to play the game in a physical real world casino. One example of a table that can be used in a physical casino is illustrated in U.S. Design patent D263,975 which is incorporated by reference herein in its entirety. The layout on top of the felt has imprinted on it multiple betting areas for each player, such as the betting areas illustrated in FIG. 4. The felt can be green and the imprinted betting circles can be white, although of course any color scheme can be used. Such a table can accommodate any number of players (e.g. 2-8). All players play simultaneously against the dealer as known in the art.

A dealer's hand 501 is shown of three cards with the dealer's discarded card 502 shown put aside. A player's first hand 503 and a player's second hand 504 are shown. This player has made all of the wagers (blind, ante 1, raise 1, ante 2, raise 2), although it is noted that the blind wager has already been resolved.

Also not pictured in FIG. 5A is an electronic mechanical shuffler such as that described in U.S. Pat. No. 8,025,294 which is incorporated by reference here in its entirety which can optionally be used by the dealer to shuffle the deck or decks of cards. Pictured in FIG. 5A is an optional shoe 505 which the cards can be placed into and dealt out of by the dealer, such as the shoe described in U.S. Pat. No. 4,457,512 which is incorporated by reference herein in its entirety.

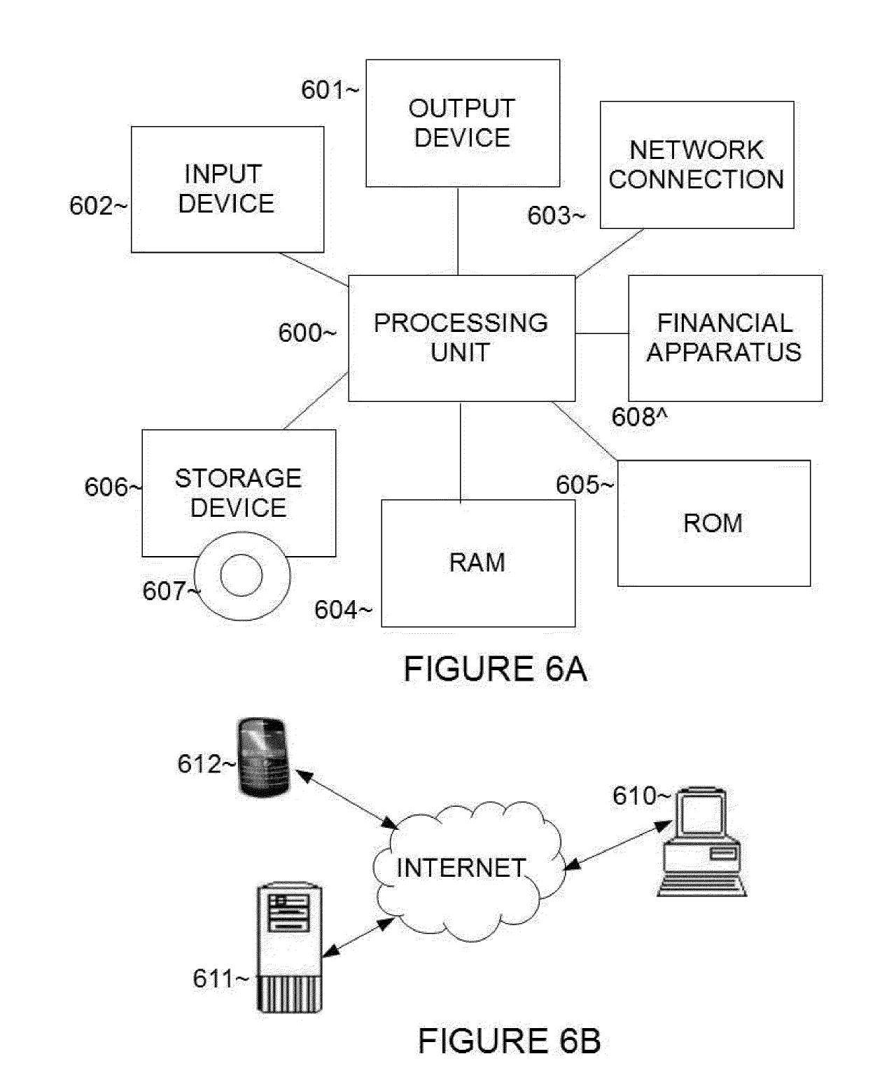

FIG. 6B is a block diagram illustrating an electronic player tracking system associated with each gaming table, according to an embodiment.

When players play casino table games the casino can typically track the player so that the casino knows how much gaming action a player is giving the casino and hence how much to reward each player with complimentaries (free or discounted rooms, food, etc.) Such a system is described in U.S. Pat. No. 5,836,817, which is incorporated by reference herein in its entirety for all purposes. Each player can have their own players card which is a plastic card that has their name imprinted on it and computer readable indicia (e.g., a magnetic stripe) which stores an identification number of the player's card (and hence the identification number of the player who owns the card). The player's card can be swiped through electronic card readers 523, 525, 526 which can be electronically read and the data therein transmitted to the associated computer.

A gaming table A 520 (which can be used to play any method described herein) and a gaming table B 521 (which can be used to play any method described herein) can be associated with a pit 522 (which has its own computer) which has a card reader 523 to read the electronically encoded information on a player's card (the card reader can also be located at the tables themselves) and transmit the information to an associated computer which can communicate information contained on the player's card (e.g., an identification number of the player associated with the card) to the electronic database 524 along with play data relating to the player who owns the player's card. Table A 520 has its own card reader 525 and associated computer (the one next to card reader 525 which receives information from the card reader 525) and table B 521 also has its own card reader 526 and associated computer (the one next to card reader 526 which receives information from the card reader 526). The computers at table A 520 and table B 521 are connected to the electronic database 524. Casino employees can enter data regarding each player's play (for those players that present a players card) into a computer at the table or at the pit which transmits the play data (e.g., average bet amount, time of play, etc.) to the electronic casino database 524 that stores playing history information for players at the casino. The computers illustrated in FIG. 5B can all have the structure as illustrated in FIG. 6A.

FIG. 6A is a block diagram illustrating hardware that can be used to implement electronic versions of the wagering methods described herein, according to an embodiment. The hardware can be, for example, an electronic gaming machine (EGM) used in casinos. The hardware can also be a personal computer, playing the game using the Internet at an Internet casino for real money. The hardware can also be a digital casino table, for example the kind described in U.S. Pat. No. 7,775,887, which is incorporated by reference herein in its entirety. The hardware can also be any computing device, such as a cellular phone, tablet, etc., and the methods described herein can be installed as software (e.g., an app) on the device. The hardware can also be any other type of device, working individually or in conjunction with other devices. The hardware can also be a digital poker table, of the kind described in U.S. Pat. No. 7,758,411 which is incorporated by reference herein in its entirety.

A processing unit 600 (such as a microprocessor and any associated components) is connected to an output device 601 (such as an LCD monitor, touch screen, CRT, etc.) which is used to display to the player any aspect of the method, and an input device 602 (e.g., buttons, the touch screen, a keyboard, mouse, etc.) which can be used to input from the player any decision made by the player. All methods described herein can be performed by the processing unit 600 by loading and executing respective instructions. The processing unit 600 can also be connected to a network connection 603, which can connect the electronic gaming device to a computer communications network such as the Internet, a LAN, WAN, etc. The processing unit 600 is also connected to a RAM 604 and a ROM 605. The processing unit 600 is also connected to a storage device 606 which can be a DVD-drive, CD-ROM, flash memory, etc. Multiple such processing units can also work in collaboration with each other (in a same or different physical location). A non-transitory computer readable storage medium 607 can store a program which can control the electronic device to perform any of the methods described herein and can be read by the storage device 606. The processing unit 600 can also be connected to a financial apparatus 608 which can receive cash and convert the received cash into playable credits for use by the player when playing the electronic device. When the player decides to cash out any remaining credits, the financial apparatus 608 can issue coins or a cashless ticket (voucher) for the remaining credits which is redeemable by the player.

While one processing unit is shown, it can be appreciated that one or more such processor can work together (either in a same physical location or in different locations) to combine to implement any of the methods described herein. Programs and/or data required to implement any of the methods/features described herein can all be stored on any non-transitory computer readable storage medium (volatile or non-volatile, such as CD-ROM, RAM, ROM, EPROM, microprocessor cache, etc.)

FIG. 6B is a block diagram illustrating an exemplary network configuration to implement a player playing an online version of the methods described herein. All the methods described herein can be implemented on an online casino for real money (credits which are purchased for cash and are redeemable for cash) or for non-cash value credits. A player uses a personal computer 610 (e.g., cell phone, tablet, PC, etc.) can connect to a server 611 (which can have the structure illustrated in FIG. 6A) using a computer communications network such as the Internet. The server 611 hosts an online casino which determines the outcomes of the game and serves the outcomes to the computer 610 so the computer 610 displays the outcomes to the player. Other users can also play at the online casino hosted by the server 611 simultaneously, such as using a cell phone 612 with wireless internet connectivity. Any number of players connected to the internet can play contemporaneously at the sever 611. The general structure of online casinos is well known in the art.

It is noted that the methods described herein can be played with any number of standard decks of 52 cards (e.g., 1 deck to 10 decks). A standard deck is a collection of cards comprising an Ace, two, three, four, five, six, seven, eight, nine, ten, jack, queen, king, for each of four suits (comprising spades, diamonds, clubs, hearts) totaling 52 cards. Cards can be shuffled or a continuous shuffling machine (CSM) can be used. A standard deck of 52 cards can be used, as well as other kinds of decks, such as Spanish decks, decks with wild cards, etc. The operations described herein can be performed in any sensible order. Furthermore, numerous different variants of house rules can be applied.

Note that in the embodiments played using computers (a processor/processing unit), “virtual deck(s)” of cards are used instead of physical decks. A virtual deck is an electronic data structure used to represent a physical deck of cards which uses electronic representations for each respective card in the deck. A virtual card is displayed on an electronic output device using computer graphics and is displayed to mimic a real life image of that card.

Methods described herein can also be played on a physical table using physical cards and physical chips used to place wagers. Such physical chips can be directly redeemable for cash. When a player wins (dealer loses) the player's wager, the dealer will pay that player a respective payout amount. When a player loses (dealer wins) the player's wager, the dealer will take (collect) that wager from the player and typically place those chips in the dealer's chip rack. All rules, embodiments, features, etc. of a game being played are typically communicated to the player (e.g., verbally or on a written rule card) before the game begins.

Initial cash deposits can be made into the electronic gaming machine which converts cash into electronic credits. Wagers can be placed in the form of electronic credits, which can be cashed out for real coins or a ticket (e.g., ticket-in-ticket-out) which can be redeemed at a casino cashier or kiosk for real cash and/or coins.

The word “deal” as used herein can mean two things: a) physically deal a card from a deck (real or virtual) face up or face down; b) reveal (turn face up a face down card) which was previously dealt. Thus, “dealing” includes taking a card from the shoe (if one is being used) and putting it on the table (face up or face down), or taking a card from the shoe (if one is being used) and putting it face down on the table and then (at a later point in time) turning it face up. Thus, if a three card hand is dealt two cards face up and one card face down (which is turned face up later), or a three card hand is dealt two cards face up and at a later time the third card is dealt face up, these are equivalent and both fall under the word “deal.”

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All variations and features described herein can be combined with any other features described herein without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method to play a game, comprising:
receiving a first ante wager and a second ante wager from a player;
dealing the player a player's initial hand of exactly X cards and dealing the dealer a dealer's initial hand of cards;
receiving a selection from the player to split the player's initial hand into a first player's hand and a second player's hand;
providing raise rules comprising receiving a selection from the player from a set comprising 1) raise which receives a raise wager from the player and 2) fold in which the player loses a respective ante wager;
implementing the raise rules for the first player's hand and the second player's hand;
dealing any additional cards as needed to the first player's hand so that the first player's hand has exactly Z cards;
dealing any additional cards as needed to the second player's hand so that the second player's hand has exactly Z cards;
playing out the dealer's initial hand using house rules into a dealer's final hand;
provide wager resolution rules comprising resolving a respective ante wager based on a comparison between the dealer's final hand and the player's respective hand; and
implementing the wage resolution rules for the player's first hand and implementing the wager resolution rules for the player's second hand.

2. The method as recited in claim 1, wherein X=4.

3. The method as recited in claim 2, wherein Z=3.

4. The method as recited in claim 1, wherein the raise rules further comprise the respective hand wins instantly if the respective hand meets a predetermined condition.

5. The method as recited in claim 4, wherein the predetermined condition is the respective hand is a predefined three card hand.

6. The method as recited in claim 1, wherein the playing out the dealer's initial hand comprises applying house rules in which the dealer reveals all cards in the dealer's initial hand and discards at least one of the dealer's initial hand.

7. The method as recited in claim 6, wherein there are exactly four cards in the dealer's initial hand and the dealer discards exactly one card to make a best three card hand.

8. The method as recited in claim 1, wherein the wager resolution rules further comprise if the dealer's final hand does not qualify then the first ante wager if live pushes and the second ante wager if live pushes while all raise bets are still live.

9. The method as recited in claim 8, wherein the wager resolution rules further comprise if the player's respective hand ranks higher than the dealer's final hand and the dealer qualifies then the both the respective ante wage rand raise wager win, and if the player's respective hand ranks lower than the dealer's final hand and the dealer qualifies then both the respective ante wager and raise wager lose.

10. The method as recited in claim 1, further wherein the dealing the dealer's initial hand deals at least one card face up and the remaining cards face down.

11. An electronic gaming apparatus, comprising:
an electronic input device;
an electronic output device;
an electronic storage device;
a circuit comprising an electronic processor operationally connected to the input device and the output device and the storage device, the storage device comprising computer readable instructions which are programmed such that when executed by the processor cause the processor to:
receive a first ante wager and a second ante wager from a player;
deal the player a player's initial hand of exactly X cards and dealing the dealer a dealer's initial hand cards;
receive a selection from the player to split the player's initial hand into a first player's hand and a second player's hand;
provide raise rules comprising receive a selection from the player from a set comprising 1) raise which receives a raise wager from the player and 2) fold in which the player loses a respective ante wager;
implement the raise rules for the first player's hand and the second player's hand;
deal any additional cards as needed to the first player's hand so that the first player's hand has exactly Z cards;
deal any additional cards as needed to the second player's hand so that the second player's hand has exactly Z cards;
play out the dealer's initial hand using house rules into a dealer's final hand;
provide wager resolution rules comprising resolve a respective ante wager based on a comparison between the dealer's final hand and the player's respective hand; and
implement the wage resolution rules for the player's first hand and implementing the wager resolution rules for the player's second hand.

12. The apparatus as recited in claim 11, wherein the computer readable instructions are further programmed such that X=4.

13. The apparatus as recited in claim 12, wherein the computer readable instructions are further programmed such that wherein Z=3.

14. The apparatus as recited in claim 11, wherein the computer readable instructions are further programmed such that the raise rules further comprise the respective hand wins instantly if the respective hand meets a predetermined condition.

15. The apparatus as recited in claim 14, wherein the computer readable instructions are further programmed such that the predetermined condition is the respective hand is a three card natural hand.

16. The apparatus as recited in claim 11, wherein the computer readable instructions are further programmed such that the playing out the dealer's initial hand comprises applying house rules in which the dealer reveals all cards in the dealer's initial hand and discards at least one of the dealer's initial hand.

17. The apparatus as recited in claim 16, wherein the computer readable instructions are further programmed such that there are exactly four cards in the dealer's initial hand and the dealer discards exactly one card to make a best three card hand.

18. The apparatus as recited in claim 11, wherein the computer readable instructions are further programmed such that the wager resolution rules further comprise if the dealer's final hand does not qualify then the first ante wager if live pushes and the second ante wager if live pushes while all raise bets are still live.

19. The apparatus as recited in claim 18, wherein the computer readable instructions are further programmed such that the wager resolution rules further comprise if the player's respective hand ranks higher than the dealer's final hand and the dealer qualifies then the both the respective ante wage rand raise wager win, and if the player's respective hand ranks lower than the dealer's final hand and the dealer qualifies then both the respective ante wager and raise wager lose.

20. The apparatus as recited in claim 11, wherein the computer readable instructions are further programmed such that the dealing the dealer's initial hand deals at least one card face up and the remaining cards face down.
